(19) United States
(12) Patent Application Publication
(10) Pub. No.: US 2025/0356858 A1
(43) Pub. Date: Nov. 20, 2025

(54) METHOD AND SYSTEM OF TRAINING AN AI NEURAL NETWORK IN DEPLOYMENT OF VOICE BASED AUTHENTICATION FOR A REMOTE EXAMINATION SETTING

(71) Applicant: EXAMROOM.AI CORP., LAKE MARY, FL (US)

(72) Inventors: VINOD KUMAR JAYAKEERTHI, Sorrento, FL (US); PHILIP DUWAYNE DICKISON, Clearwater Beach, FL (US); HENRY LUND SORENSEN, Sandy, UT (US); BHARATH VIRUPAKSHAPPA SAGAR, Shimoga (IN); DEEPAK MADHUKAR KOLEKAR, Bengaluru (IN); ADARSH SINGH DIKHIT, Satna (IN)

(21) Appl. No.: 18/983,508

(22) Filed: Dec. 17, 2024

Related U.S. Application Data
(60) Provisional application No. 63/648,854, filed on May 17, 2024.

(51) Int. Cl. G10L 17/04; G10L 17/18

(52) U.S. Cl. CPC G10L 17/04; G10L 17/18

(57) ABSTRACT

A method and system of training an artificial intelligence (AI) neural network in authenticating a voice fingerprint. The method includes extracting data from a training dataset of voice fingerprints with an AI neural network that includes a residual convolutional neural network (ResCNN), generating processed voice fingerprint data from the extracted data based at least in part on a softmax function implemented in accordance with a softmax layer of the ResCNN, preparing a training dataset and a validation dataset of voice fingerprints based on the processed voice fingerprint data, training the AI neural network based on the training dataset and validating the trained AI neural network based at least in part on the validation dataset.

### RELATED APPLICATIONS

This application claims the benefit of priority to U.S. Provisional Patent Application No. 63/648,854 filed on May 17, 2024. Said U.S. Provisional Patent Application No. 63/648,854 is hereby incorporated in its entirety.

### TECHNICAL FIELD

Disclosures herein relate to distributed computer network systems for remote examination contexts including training of AI neural networks for deployment therein.

### BACKGROUND

The introduction and acceleration of online examinations has necessitated the need for secure and reliable technologies that facilitate a seamless testing experience while maintaining the integrity of the online examination ecosystem, including related examination proctoring solutions. In a remote proctored online examination, candidate identity and environment must be verified, accurately and consistently, before the candidate can access confidential examination content and begin participation in the examination. From a practical standpoint, it can be challenging for remote proctoring solutions to determine if purported examination candidates are in fact who they claim to be. To the extent that attempts to circumvent candidate verification are successful, integrity of the examinations and consequentially, public confidence in professionals and attendant professional standards related thereto, are at risk of compromise.

### DESCRIPTION OF THE DRAWINGS

Whereas novel aspects believed characteristic of the invention are set forth in the appended claims, embodiments described herein will be understood by those of skill in the art with reference to the following detailed description and the accompanying drawing figures, in which like reference numerals indicate similar or identical features and components.

FIG. 1 shows, in an example embodiment, a distributed computer network system for training and deployment of voice based candidate authentication in a remote examination setting.

FIG. 2 shows, in an example embodiment, an architecture of a computer system for training and deployment of voice based candidate authentication.

FIG. 3 shows, in an example embodiment, a candidate registration process related to training an artificial intelligence (AI) neural network in a voice based remote candidate authentication system.

FIG. 4 shows, in an example embodiment, a candidate validation process related to deployment of an (AI) neural network in a voice based remote candidate authentication system.

FIG. 5 shows, in an example embodiment, a process for training an (AI) neural network in a voice based candidate authentication system.

FIG. 6 shows, in an example embodiment, a process for deploying an (AI) neural network in a voice based candidate authentication system.

### DETAILED DESCRIPTION

Embodiments herein recognize challenges in proctoring and administering online examinations for remotely located examination candidates (also referred to herein as “candidate” herein) while maintaining integrity and quality standards of the examination process without undue risk of compromise. Among other advantages and benefits, techniques for training an AI neural network neural network which can then be deployed in secure, efficient and failsafe proctoring and administering of online examinations for remotely located candidates are provided.

Provided is a method of training an AI neural network in authenticating a voice fingerprint of a candidate for a remotely proctored examination setting. The method includes extracting data from a training dataset of voice fingerprints with an AI neural network that includes a residual convolutional neural network (ResCNN), generating processed voice fingerprint data from the extracted data based at least in part on a softmax function implemented in accordance with a softmax layer of the ResCNN, preparing a training dataset and a validation dataset of voice fingerprints based on the processed voice fingerprint data, training the AI neural network based on the training dataset and validating the trained AI neural network based at least in part on the validation dataset.

Further provided is a computer-readable non-transitory memory having instructions stored thereon. The instructions are executable to cause one or more processors to implement operations including extracting data from a training dataset of voice fingerprints with an artificial intelligence (AI) neural network, the AI neural network comprising a residual convolutional neural network (ResCNN), generating processed voice fingerprint data from the extracted data based at least in part on a softmax function implemented in accordance with a softmax layer of the ResCNN, preparing a training dataset and a validation dataset of voice fingerprints based at least in part on the processed voice fingerprint data, training the AI neural network based at least in part on the training dataset and validating the trained AI neural network based at least in part on the validation dataset.

Also provided is an examination proctoring computer system having one or more processors and a memory storing instructions executable in the one or more processors, the instructions when executed causing the one or more processors to implement operations that include receiving, from a candidate computing device that is interconnected with the examination proctoring computing system within a distributed network computing system, a voice sample purportedly associated with an examination candidate remotely located relative to the examination proctoring computing device, generating a voice fingerprint in accordance with the voice sample and authenticating the examination candidate based on the generated voice fingerprint in accordance with a trained AI neural network. In some embodiments, the operations further include authenticating the examination candidate based at least in part on a liveness detection measurement in conjunction with a threshold percentage match with a pre-existing registration voice sample associated with the examination candidate.

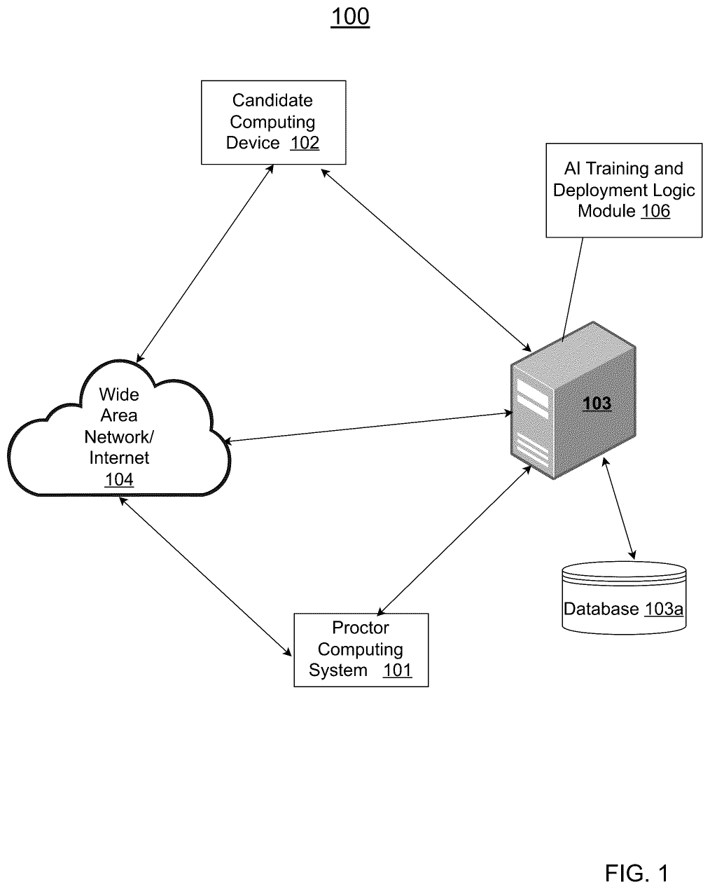

FIG. 1 shows, in an example embodiment, distributed computer network system 100 for training and deployment of voice based candidate authentication in a remote examination setting.

In embodiments, the neural network in accordance with AI training and deployment logic module 106 of server computing system 103 may be instantiated in a memory of server 103 or proctor computing system 101 via execution of processor-executable instructions stored thereon in one or more processor devices. Server computing system 103 may be interconnected with database 103a, or in some embodiments, incorporate database 103a. It is contemplated that the instructions executable to instantiate the AI neural network may be stored in portions or components across server computing system 103 in conjunction with proctor computing system 101 and implemented in parts or in whole across one or both, in embodiments. Server computing system 103 and proctor computing system 101 may be interconnected directly, or via a local area network or wide area network 104, in some embodiments. In this manner, the AI neural network may be instantiated by processor devices and memory in any one of server computing system 103 and proctor computing system 101 or across both server computing system 103 and proctor computing system 101 working cooperatively in conjunction, as will be apparent to those of skill in the art of distributed computer networking systems and cloud computing systems.

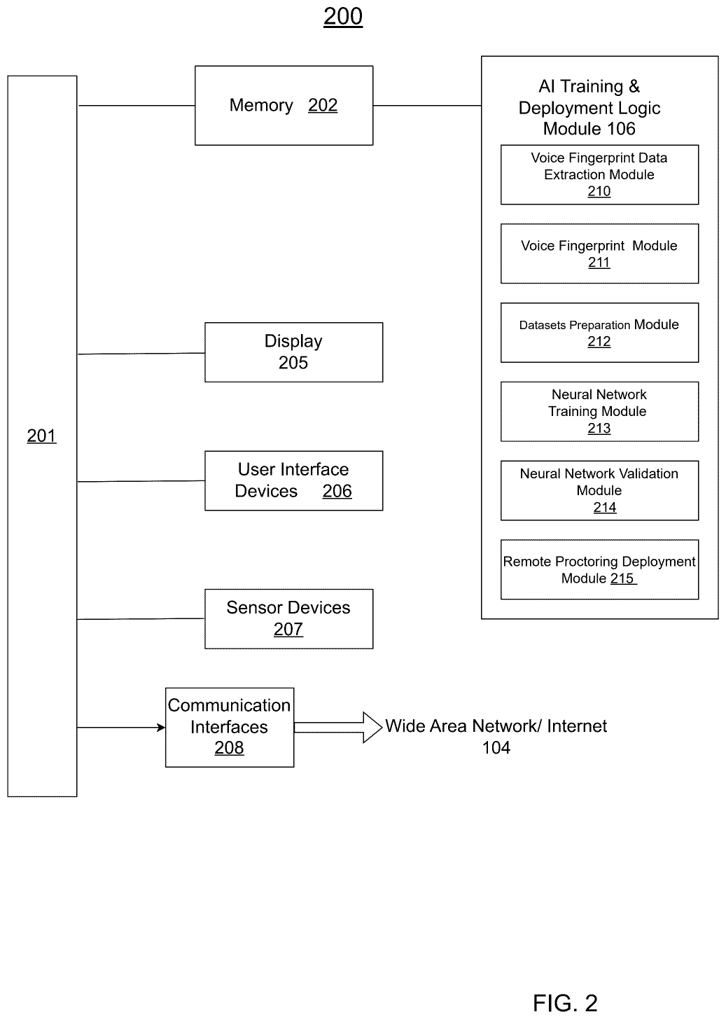

FIG. 2 shows, in an example embodiment, architecture 200 of a computer system for training and deployment of voice based candidate authentication. The example embodiment of architecture 200 will next be described with reference to server computing system 103. However, it is contemplated that, as will be appreciated by ones of skill in the art of distributed computing networks, at least some portions of logic componentry and functionality ascribed to server computing system 103 may be incorporated into proctor computing system 101, or similar interconnected computing systems, in alternate or additional embodiments. For instance, it is contemplated that at least some of the functionality of AI training and deployment logic module 106, including voice fingerprint data extraction module 210, voice fingerprint module 211, datasets preparation module 212, neural network training module 213, neural network validation module 214 and remote proctoring deployment module 215 may be implemented or incorporated variously, including in portions or an entirety, across server computing system 103 in conjunction with proctor computing system 101.

AI training and deployment logic module 106, constituted of voice fingerprint data extraction module 210, voice fingerprint module 211, datasets preparation module 212, neural network training module 213, neural network validation module 214 and remote proctoring deployment module 215 may be implemented using programmable instructions stored in memory 202, and being executable in one or more processor devices, including such as processor 201. Memory 202 may include, though not necessarily be limited to, non-volatile memory device(s), including dynamic random access memory (DRAM) or static random access memory (SRAM) non-transitory memory storage media or devices, and any combinations thereof. Although functionality ascribed to AI training and deployment logic module 106 is described herein, for sake of providing clarity to ones of ordinary skill in the art, in context of discrete logic modules, specifically voice fingerprint data extraction module 210, voice fingerprint module 211, datasets preparation module 212, neural network training module 213, neural network validation module 214 and remote proctoring deployment module 215, it is contemplated that functionality ascribed to AI training and deployment logic module 106 herein should not be limited in implementation to such literal discrete logic modules. For instance, in alternate or additional embodiments, certain aspects of functionality ascribed to those discrete modules may be incorporated or subsumed, at least in portions, variously across others of those discrete logic modules.

In some embodiments, at least portions of functionality of AI training and deployment logic module 106 including its constituent logic modules, specifically voice fingerprint data extraction module 210, voice fingerprint module 211, datasets preparation module 212, neural network training module 213, neural network validation module 214 and remote proctoring deployment module 215 may be implemented in accordance with hard-wired circuitry and electronic componentry. The hard-wired circuitry and electronic componentry may be, without limitation, such as field programmable gate array (FPGA) devices and similar hard-wired electronic circuitry and componentry implementations.

Voice fingerprint data extraction module 210 includes logic instructions for extracting data from a training dataset of voice fingerprints with the AI neural network, the AI neural network comprising a residual convolutional neural network (ResCNN). In embodiments, extracting data from the training dataset comprises extracting, from a hidden layer of the ResCNN, speaker embeddings associated with the voice fingerprints encoded in a d-vector representation that encodes the speaker characteristics into a fixed-length vector. In some embodiments, pre-processing the training dataset may include labeling the voice fingerprints with categories and identities of speakers, removing outliers, and inputting or providing missing values associated with at least a subset of the voice fingerprints. In some variations, the AI neural network further includes a gated recurrent unit (GRU).

Voice fingerprint module 211 includes logic instructions for generating processed voice fingerprint data from the extracted data based at least in part on a softmax function implemented in accordance with a softmax layer of the ResCNN. The softmax function helps in classifying speakers into different classes. For example, in some embodiments, the training dataset is subjected to removal of gender bias based at least in part on the softmax function.

Datasets preparation module 212 includes logic instructions for preparing a training dataset and a validation dataset of voice fingerprints based at least in part on the processed voice fingerprint data. In embodiments, the processed voice fingerprint data is segregated into 2 separate sets, constituting the training and the validation datasets.

Neural network training module 213 includes logic instructions for training the AI neural network based at least in part on the training dataset to produce a trained AI neural network. Training the AI neural network, in some variations, further includes training the AI neural network in accordance with a triplet loss function that minimizes the distance between embedding pairs from a same speaker and maximizes the distance between embedding pairs from different speakers in the training dataset of voice fingerprints, helping to ensure that the model brings the features of the same speaker closer together while pushing apart the features of different speakers.

Neural network validation module 214 includes logic instructions for validating the trained AI neural network based at least in part on the validation dataset. In further embodiments, validating the AI neural network further comprises determining an accuracy of the AI neural network in accordance with determining a cumulative accuracy profile of the AI neural network. In some implementations, validating the AI neural network further comprises determining an accuracy of the AI neural network in accordance with an equal error rate algorithm.

Remote proctoring deployment module 215 includes logic instructions for receiving a voice sample purportedly associated with an examination candidate, the examination candidate being remotely located relative to an examination proctoring computing device, generating a voice fingerprint in accordance with the voice sample and authenticating the examination candidate based at least in part on the generated voice fingerprint.

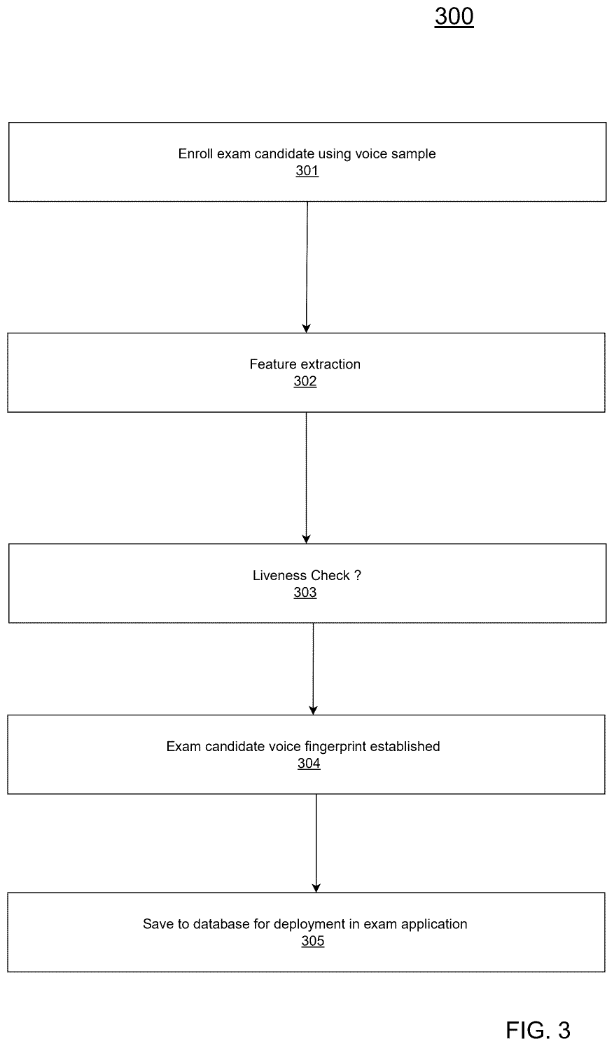

FIG. 3 shows, in an example embodiment of an initial registration process 300 related to training and deployment of an artificial intelligence (AI) neural network in a voice based remote examination candidate authentication system.

At step 301, an examination candidate (“exam candidate”) begins an initial enrollment, providing a voice sample captured as an audio file, which is typically 8 to 14 seconds long. As used herein, the term voice fingerprint refers to a digital representation of the unique vocal or audio characteristics of a given individual.

At step 302, a feature extraction process is performed on the voice sample, creating personalized calculations or vectors related to specific attributes that make the examination candidate's speech unique. Such specific attributes may include, without limitation, amplitude, speed, accent, tone, and pitch, for instance as can be captured via a spectrogram. Noise reduction techniques may be used to reduce background noise to improve the clarity of the voice signal. An affine transformation, which is a linear mapping that improves the discriminability of the speaker features, may applied to features over the speaker sentences in the audio sample. Yet further, the features may be normalized in length to ensure that the duration of the speech does not skew the voice recognition process.

At step 303, a liveness check may optionally be performed, to ensure that a live candidate, and not a recording, a spoofing attack or other simulated voice sample, is being provided.

At step 304, the enrollment candidate's voice fingerprint is established, using any suitable format, for instance a.p format.

At step 305, the voice fingerprint is saved to a suitable database for deployment in remote exam settings, based on data rates and size of voice fingerprint population size, for example.

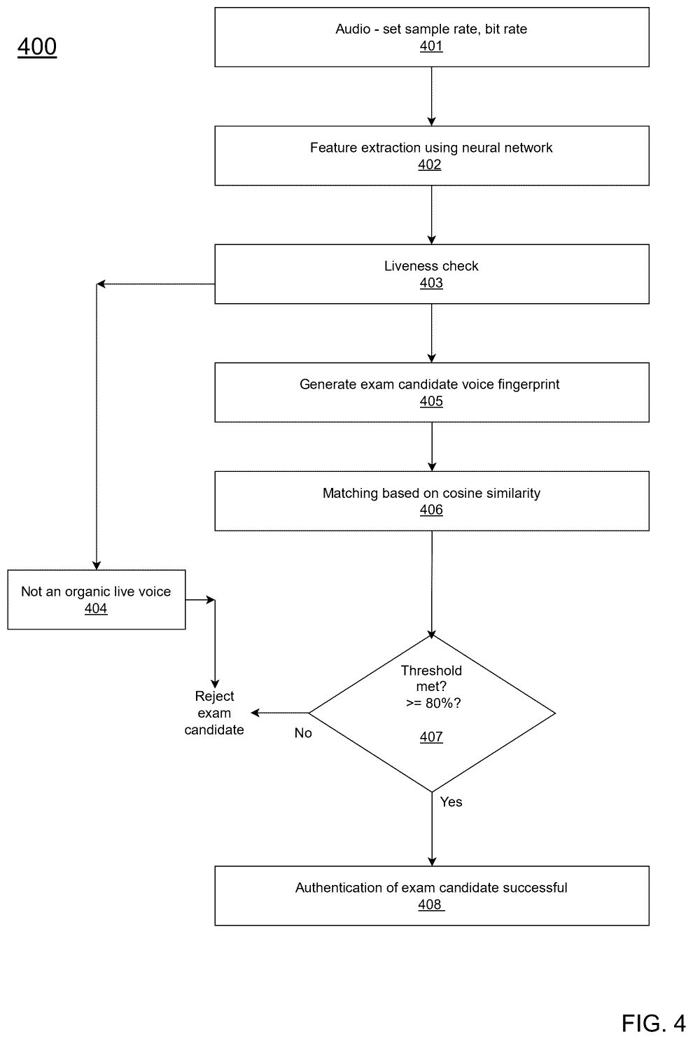

FIG. 4 shows, in an example embodiment, candidate authentication process 400 related to deployment of an (AI) neural network in a voice based authentication system for a remotely located examination candidate. As used herein, the term “remote located” refers to an examination candidate associated with a candidate computing device that is remotely located relative to an examination proctoring computing device or system.

At step 401, the exam candidate's voice sample is submitted. Desired data rate for the voice fingerprints may be pre-set, or set in real-time, including sample rate and bit rate.

At step 402, feature extraction is performed in real time on the voice sample, generating vector embeddings, for example in a d-vector representation.

At step 403, a liveness detection check is performed.

At step 404, responsive to the liveness detection check being negative, that is, the voice sample is deemed as not an organic, live voice, the exam candidate is rejected, at least based on the particular sample submitted.

At step 405, a voice fingerprint for the exam candidate is generated.

At step 406, fingerprint matching, for example based on a cosine similarity algorithm, is performed versus the established reference database of voice fingerprints. The cosine similarity algorithm may be applied to compare the voice fingerprint submitted for authentication in real time against the stored enrollment fingerprint. Cosine similarity measures the cosine of the angle between two of the embedded vectors representative of voice fingerprints, to determine how similar they are.

At step 407, a confidence level associated with the matching based on a cosine similarity is calculated and may be compared to a pre-set threshold confidence level. In an example embodiment, a confidence level threshold of 80% probability may be applied.

At step 408, responsive to the threshold confidence level being achieved or exceeded, the candidate authentication is considered successful, whereupon the candidate is enabled to access and to undertake the examination.

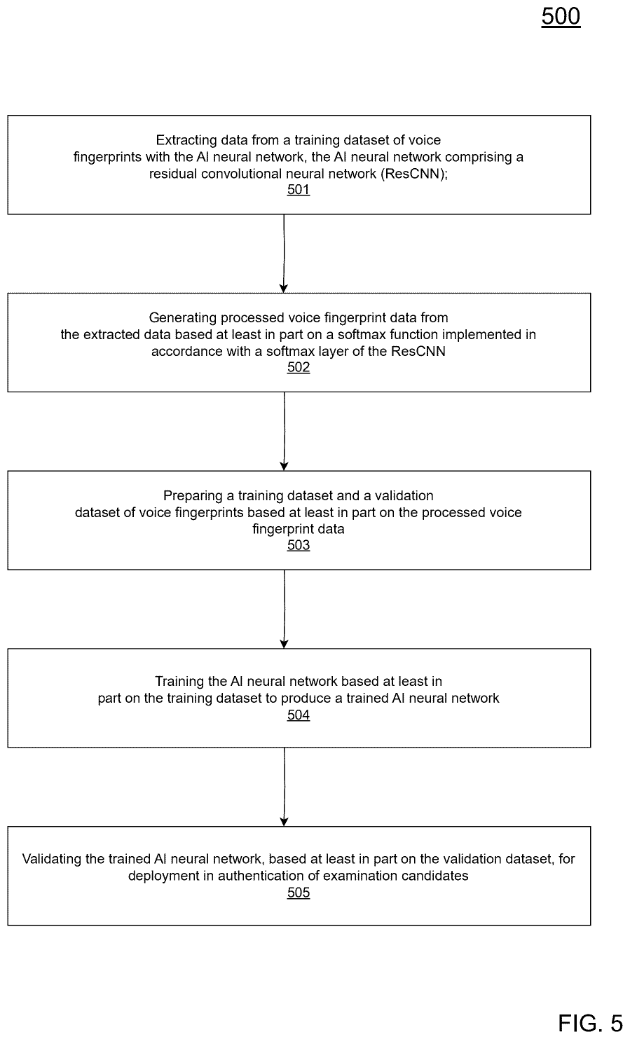

FIG. 5 shows, in an example embodiment, process 500 for training and deployment of an (AI) neural network in a voice based remote candidate authentication system.

At step 501, extracting data from a training dataset of voice fingerprints with the AI neural network, the AI neural network, in some embodiments, comprising a residual convolutional neural network (ResCNN).

At step 502, generating processed voice fingerprint data from the extracted data based at least in part on a softmax function implemented in accordance with a softmax layer of the ResCNN.

At step 503, preparing a training dataset and a validation dataset of voice fingerprints based at least in part on the processed voice fingerprint data. In embodiments, the processed voice fingerprint data may be segregated into 2 separate sets, constituting the training and the validation datasets.

At step 504, training the AI neural network based at least in part on the training dataset. In embodiments, the training can include aspects of any one, or both, supervised and unsupervised training techniques.

At step 505, validating the trained AI neural network based at least in part on the validation dataset. In embodiments, training the AI neural network may be conducted in a repeated and iterative manner until validation results, in accordance with pre-existing threshold targets or quality standards, is deemed satisfactory. In embodiments, depending on validation results, training may be ongoing, for example until false negatives (the case that the audio-matching system fails to report a match when it should have) and false positives (the case that the audio-matching system reports a match when it shouldn't have) are reduced to acceptable levels.

In embodiments, extracting data from the training dataset comprises extracting, from a hidden layer of the ResCNN, speaker embeddings associated with the voice fingerprints encoded in a d-vector representation.

In some embodiments, pre-processing the training dataset may be based on one or more of: labeling the voice fingerprints with categories and identities of speakers, removing outliers, and inputting or providing missing values associated with at least a subset of the voice fingerprints.

In some embodiments, the training dataset is subjected to removal of gender bias based at least in part on the softmax function. The softmax function helps in classifying speakers into different classes. For example, in some embodiments, the training dataset is subjected to removal of gender bias based at least in part on the softmax function.

Training the AI neural network, in some variations, further includes training the AI neural network in accordance with a triplet loss function that minimizes the distance between embedding pairs from a same speaker and maximizes the distance between embedding pairs from different speakers in the training dataset of voice fingerprints, helping to ensure that the model brings the features of the same speaker closer together while pushing apart the features of different speakers.

In further embodiments, validating the AI neural network further comprises determining an accuracy of the AI neural network in accordance with determining a cumulative accuracy profile of the AI neural network. In embodiments, the accuracy may be established in accordance with the cumulative accuracy profile approaching or reaching a steady state.

In some embodiments, validating the AI neural network further comprises determining an accuracy of the AI neural network in accordance with an equal error rate algorithm.

In some aspects, the AI neural network further includes a gated recurrent unit (GRU). GRU layers may also be implemented as an alternative for frame-level feature extraction.

In embodiments for deploying the AI neural network as trained, the method includes deploying the trained AI neural network in a remote examination session. The deploying, in an embodiment, includes receiving a voice sample purportedly associated with an examination candidate, the examination candidate being remotely located relative to an examination proctoring computing device, generating a voice fingerprint in accordance with the voice sample, and authenticating the examination candidate based at least in part on the generated voice fingerprint.

In some variations, the method further includes authenticating the examination candidate based on at least one of a liveness detection measurement and a threshold percentage match with a pre-existing registration voice sample associated with the examination candidate.

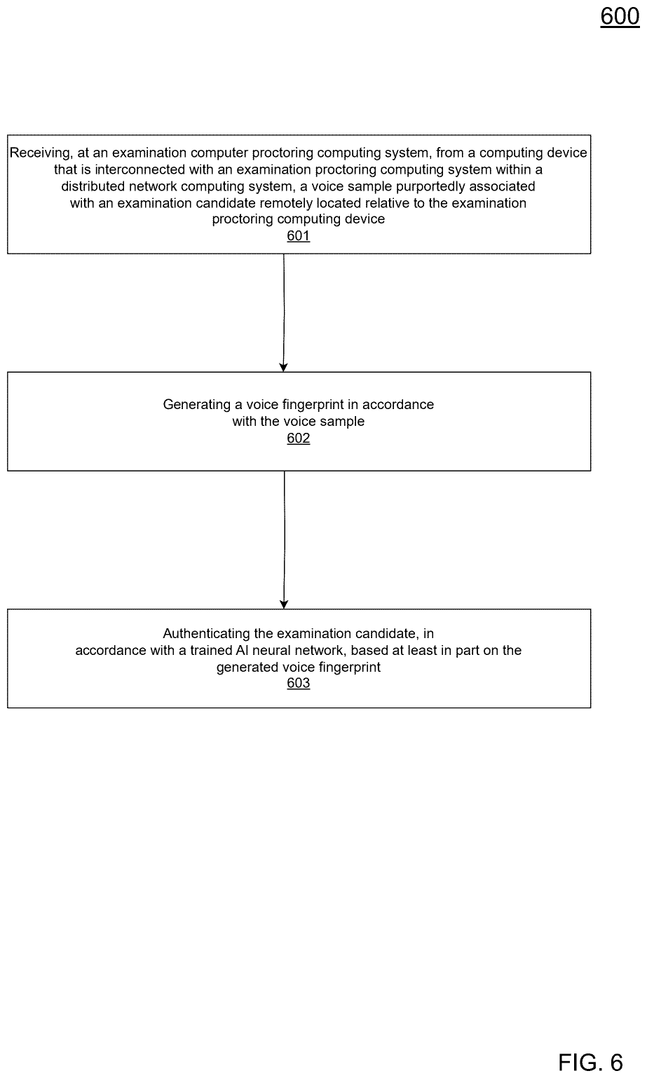

FIG. 6 shows, in an example embodiment, process 600 for deploying an (AI) neural network in a voice based candidate authentication system 100. An examination candidate may be associated with candidate computing device 102, being remotely located but communicatively accessible via wide area, distributed network 104 from an examination proctoring computer system 101, in embodiments.

Examination proctoring computer system 101 includes non-transitory, computer readable memory 202 storing processor executable instructions thereon. The instructions, when executed in one or more processors 201 of the proctoring computing system 101, cause the one or more processors to implement operations that include:

At step 601, receiving, from candidate computing device 202 that is interconnected with the examination proctoring computing system 101 within distributed network 104, a voice sample purportedly associated with the examination candidate remotely located relative to the examination proctoring computing device 101.

At step 602, generating a voice fingerprint in accordance with the voice sample.

At step 603, authenticating, in accordance with a trained AI neural network, the examination candidate based at least in part on the generated voice fingerprint. In related embodiments, the instructions further cause the one or more processors to implement operations comprising authenticating the examination candidate based on a liveness detection measurement and a threshold percentage match with a pre-existing registration voice sample associated with the examination candidate.

It is contemplated that embodiments described herein be understood to include and encompass varying combinations of elements and concepts recited anywhere in this application. Although embodiments are described in detail herein with reference to the accompanying drawings, it is to be understood that the invention is not limited to only such literal embodiments. For example, it is anticipated that the techniques and systems may be applied or deployed to cases other than remotely located candidates and examination settings As such, many modifications and variations will be apparent to practitioners skilled in the art. Accordingly, it is intended that the scope of the invention be defined by the following claims and their equivalents. Furthermore, it is contemplated that a particular feature described either individually or as part of an embodiment can be combined with other features individually described, or parts of other embodiments, even in the absence of such particular described combinations. Thus, absence of any such particular described combinations does not preclude the inventor from claiming rights to such combinations.

What is claimed is:

1. A method of training an artificial intelligence (AI) neural network in authenticating a voice fingerprint, the method comprising:
extracting data from a training dataset of voice fingerprints with the AI neural network, the AI neural network comprising a residual convolutional neural network (ResCNN);
generating processed voice fingerprint data from the extracted data based at least in part on a softmax function implemented in accordance with a softmax layer of the ResCNN;
preparing a training dataset and a validation dataset of voice fingerprints based at least in part on the processed voice fingerprint data;
training the AI neural network based at least in part on the training dataset to produce a trained AI neural network; and
validating the trained AI neural network based at least in part on the validation dataset.

2. The method of claim 1, wherein extracting data from the training dataset comprises extracting, from a hidden layer of the ResCNN, speaker embeddings associated with the voice fingerprints encoded in a d-vector representation.

3. The method of claim 1, further comprising pre-processing the training dataset based on one or more of: labeling the voice fingerprints with categories and identities of speakers, removing outliers, and one of inputting and providing missing values associated with at least a subset of the voice fingerprints.

4. The method of claim 3 wherein the training dataset is subjected to removal of gender bias based at least in part on the softmax function.

5. The method of claim 1, wherein training the AI neural network further comprises training the AI neural network in accordance with a triplet loss function that minimizes the distance between embedding pairs from a same speaker and maximizes the distance between embedding pairs from different speakers in the training dataset of voice fingerprints.

6. The method of claim 1, wherein validating the AI neural network further comprises determining an accuracy of the AI neural network in accordance with determining a cumulative accuracy profile of the AI neural network.

7. The method of claim 1, wherein validating the AI neural network further comprises determining an accuracy of the AI neural network in accordance with an equal error rate algorithm.

8. The method of claim 1, wherein the AI neural network further comprises a gated recurrent unit (GRU).

9. The method of claim 1 wherein training the AI neural network produces a trained AI neural network, and further comprising deploying the trained AI neural network in a remote examination session, the deploying comprising:
receiving a voice sample purportedly associated with an examination candidate, the examination candidate being remotely located relative to an examination proctoring computing device;
generating a voice fingerprint in accordance with the voice sample; and
authenticating the examination candidate based at least in part on the generated voice fingerprint.

10. The method of claim 9 further comprising authenticating the examination candidate based at least in part on a liveness detection measurement and a threshold percentage match with a pre-existing registration voice sample associated with the examination candidate.

11. An examination proctoring computer system comprising:
one or more processors; and
a memory storing instructions executable in the one or more processors, the instructions when executed causing the one or more processors to implement operations comprising:
receiving, from a candidate computing device that is interconnected with the examination proctoring computing system within a distributed network computing system, a voice sample purportedly associated with an examination candidate remotely located relative to the examination proctoring computing device;
generating a voice fingerprint in accordance with the voice sample; and
authenticating the examination candidate, in accordance with a trained AI neural network, based at least in part on the generated voice fingerprint.

12. The examination proctoring computing system of claim 11 wherein the instructions further cause the one or more processors to implement operations comprising authenticating the examination candidate based at least in part on a liveness detection measurement and a threshold percentage match with a pre-existing registration voice sample associated with the examination candidate.

13. A computer-readable non-transitory memory having instructions stored thereon, the instructions being executable to cause one or more processors to implement operations comprising:
extracting data from a training dataset of voice fingerprints with an artificial intelligence (AI) neural network, the AI neural network comprising a residual convolutional neural network (ResCNN);
generating processed voice fingerprint data from the extracted data based at least in part on a softmax function implemented in accordance with a softmax layer of the ResCNN;
preparing a training dataset and a validation dataset of voice fingerprints based at least in part on the processed voice fingerprint data;
training the AI neural network based at least in part on the training dataset to produce a trained AI neural network; and
validating the trained AI neural network based at least in part on the validation dataset.

14. The computer-readable non-transitory memory of claim 13, the instructions being executable in the one or more processors to cause operations comprising extracting data from the training dataset comprises extracting, from a hidden layer of the ResCNN, speaker embeddings associated the voice fingerprints encoded in a d-vector representation.

15. The computer-readable non-transitory memory of claim 13, the instructions being executable in the one or more processors to cause operations comprising pre-processing the training dataset based on one or more of: labeling the voice fingerprints with categories and identities of speakers, removing outliers, and one of inputting and providing missing values associated with at least a subset of the voice fingerprints.

16. The computer-readable non-transitory memory of claim 15, the instructions being executable in the one or more processors to cause operations comprising the training dataset is subjected to removal of gender bias based at least in part on the softmax function.

17. The computer-readable non-transitory memory of claim 13, wherein the instructions cause the one or more processors to implement operations comprising training the AI neural network in accordance with a triplet loss function that minimizes the distance between embedding pairs from a same speaker and maximizes the distance between embedding pairs from different speakers in the training dataset of voice fingerprints.

18. The computer-readable non-transitory memory of claim 13, wherein the instructions cause the one or more processors to implement operations comprising validating the AI neural network further comprises determining an accuracy of the AI neural network in accordance with determining a cumulative accuracy profile of the AI neural network.

19. The computer-readable non-transitory memory of claim 13, wherein the instructions cause the one or more processors to implement operations comprising validating the AI neural network further comprises determining an accuracy of the AI neural network in accordance with an equal error rate algorithm.

20. The computer-readable non-transitory memory of claim 13, wherein the AI neural network further comprises a gated recurrent unit (GRU).
